(19) United States
(12) Patent Application Publication
(10) Pub. No.: US 2007/0270095 A1
(43) Pub. Date: Nov. 22, 2007

(54) Car air conditioner

(75) Inventors: Youhei Shimoyama, Kariya-city (JP); Kouji Itoh, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/803,624

(22) Filed: May 15, 2007

(30) Foreign Application Priority Data
May 17, 2006 (JP) 2006-137814
Dec. 20, 2006 (JP) 2006-342973

(51) Int. Cl. B60H 1/30; B60H 3/00

(52) U.S. Cl. 454/148; 454/156

(57) ABSTRACT

A construction of a filter 170 that allows air stream from a blower fan 120 to pass through a heat exchanger 130 arranged adjacent to the blower fan 120 after its flowing direction is changed by about 90 degrees. The filter 170 is disposed on the front surface of the heat exchanger on the upstream side of the air flow and has a construction such that airflow resistance of the filter gradually changes with respect to the flow velocity of air passing through the filter and in this way, flow velocity distribution of air passing through the heat exchanger becomes uniform. In this case, a fold pitch P of folds of the filter that is folded or a peak height h of the folds is changed in a plurality of steps or without any steps.

### BACKGROUND OF THE INVENTION

1. Field of the Invention

This invention relates to a car air conditioner equipped with a filter for purifying air inside a passenger compartment.

2. Description of the Related Art

An HVAC (Heating Ventilating and Air Conditioning) unit of a car air conditioner according to the prior art employs a so-called “blower offset installation system” in which a blower fan 1 is arranged adjacent to an evaporator (heat exchanger) 8 in a transverse direction of a car body as shown in FIG. 13. In this case, a folded filter 7 shown in FIG. 13 is arranged on the upstream side of the blower fan 1 in an air flowing direction. A wall surface of a case portion 6 opposing the heat exchanger 8 is shaped into a step shape on the upstream side of the heat exchanger 8 and each step portion is inclined so that a gap between the wall surface of the case portion 6 and the heat exchanger 8 becomes progressively smaller at positions spaced away from the fan 1 in order for the flow of air flowing into the heat exchanger 8 to be uniform. However, as the flowing direction of air emitted from the blower fan 1 is changed substantially 90° in front of the heat exchanger 8, complicated air flow is created inside the case portion 6 on the upstream side of the heat exchanger. Consequently, a flow velocity distribution of air cannot always be rendered uniform by merely shaping the wall surface of the case portion 6 into the step shape with each step being inclined. In the car air conditioner of the prior art, the width A (mm) in the longitudinal direction of the car body cannot be reduced. Therefore, the applicant of the present invention has completed the invention after noticing that a filter has a unidirectional (straightening) effect.

Patent documents 1 to 4 are known as references that disclose the filter construction according to the prior art. In the filter member disclosed in patent document 1 (Japanese Unexamined Patent Publication No. 11-76729), a fold pitch P of the filter 7 is gradually changed in such a manner as to correspond to the flow velocity of air flowing inside a duct as shown in FIG. 14. According to this construction, air having a high flow velocity can be received by a filter portion having a small fold pitch P, that is, a filter portion having a large filtration area, and air having a low velocity can be received by a filter portion having a large fold pitch P, that is, a filter portion having a small filtration area. In this way, the flow velocity of air passing through a unit area of the filter is made uniform as a whole and variance of dust collection efficiency (dust collection amount per predetermined time per unit time) is eliminated.

However, an optimal pitch at which a blast resistance becomes minimal exists in the fold pitch P of the filter 7. When the fold pitch is smaller than the optimal pitch, the gap between a peak and a valley is reduced and blast resistance increases because of influences of fluid friction. As a result, the flow velocity per unit area of the filter cannot be rendered uniform unless the filter portion that receives air having the highest flow velocity optimally pitched.

Patent document 1 is directed to eliminate the variance of dust collection efficiency by making the fold pitch P small at the center portion at which flow velocity is high and great at the peripheral portion at which flow velocity is low, to thereby make uniform the flow velocity of air passing through the unit area of the filter. However, document 1 is not directed to lower a pressure loss by making uniform the flow velocity distribution of air passing through the filter. To make the flow velocity distribution uniform, air having a low flow velocity must be received by the filter portion having the optimal pitch to achieve the smallest pressure loss, contrary to the above. As the filter area per unit area in the air blowing direction increases at the optimal pitch, the air quantity passing through the unit area of the filter is reduced and pressure loss is less. When the pitch is smaller than the optimal pitch, on the other hand, the gap between the peak and the valley of the fold is reduced, so that fluid friction increases. When the pitch is greater than the optimal pitch, the quantity of air passing through the unit area of the filter increases in the air blowing direction and pressure loss increases. Therefore, patent document 1 does not reduce pressure loss by making uniform the flow velocity distribution of air passing through the filter.

Patent document 2 (Japanese Unexamined Utility Model Publication No. 6-18021)) describes a filter construction capable of exhibiting a dust collection operation without a drop in the dust collection capacity of the filter 7 by increasing the width of an air passage formed between the filter 7 and cowl top on the upstream side or by decreasing the width on the downstream side.

This filter construction gradually changes the height h of the peak of the fold, however, it does not make uniform the flow velocity distribution of air passing through the filter by changing the blast resistance.

The air cleaner element used for the air cleaner of an internal combustion engine described in patent document 3 (Japanese Unexamined Patent Publication No. 62-79827) represents a filter construction in which the height of the peak folded as shown in FIG. 16 gradually becomes greater from the center to the outer edge in order to allow air to pass through the filter over the entire filter element surface, and reduces the thickness, size and weight of the air cleaner.

However, in the blower offset (semi-center) installation HVAC unit described above, the blower is arranged adjacent to the evaporator in the transverse direction of the car body and the air flow velocity direction becomes progressively higher at positions spaced apart from the blower. Therefore, when the filter is arranged in front of the evaporator, this shape cannot make uniform the flow velocity distribution of air passing through the filter.

The filter unit of patent document 4 (Japanese Unexamined Patent Publication No. 64-34420) represents a construction in which the filter area per unit area of the air-blowing out surface is changed as shown in FIG. 17 so that the velocity of the airflow is different between the free space 3, in which the degree of cleanness is not high inside the clean room, and a high cleanness area 4 having a high degree of cleanness inside the clean room such as a convey passage. However, the filter unit of this patent document 4 does not lower the pressure loss by making uniform the flow velocity distribution of air passing through the filter. The surface of the filter 7 on the flowing-out side is flat and the height h of the peak on the suction side is changed.

As described above, none of the filters of patent 1 to 4 lower the pressure loss by making the flow velocity distribution of air passing through the filter uniform.

The object of the filter unit of patent document 4 is to change the blow-out air velocity by changing an area of a filter brazing material per unit area of the air blowing out surface.

### SUMMARY OF THE INVENTION

In view of the problems of the prior art described above, it is an object of the invention to provide a car air conditioner that makes it possible to render uniform a flow velocity distribution of air flowing into a heat exchanger through a filter and to straighten the air flow in order to reduce pressure loss and decrease the length in a longitudinal direction of a car body.

According to one aspect of the invention, there is provided an air conditioner, which comprises an air conditioner case 101 having a first blast passage 101a for causing air sucked from a suction port to flow horizontally in a transverse direction of a car body or vertically in a vertical direction of the car body and a second blast passage 101b for changing the flowing direction of an air stream from the first blast passage substantially 90° and sending it towards a blast port; a blower fan 120 arranged inside the air conditioner case 101, for blowing air sucked from the suction port in the transverse direction or the vertical direction of the car body; a heat exchanger 130 aligned with the blower fan 120 in the transverse direction or vertical direction of the car body, and arranged inside the second blast passage; and a filter 170 arranged on the upstream side of the heat exchanger 130 inside the second blast passage; wherein the filter 170 is constituted in such a manner that blast resistance of the filter is reduced on the side closer to the blower fan 120 and becomes progressively greater at positions spaced away from the blower fan with respect to flow velocity of air passing through the filter. This construction can make uniform the flow velocity distribution of air passing through the heat exchanger 130 and can straighten the air stream.

In the car air conditioner according to the invention, the filter 170 is folded, and a fold pitch P is an optimal pitch Po having the smallest blast resistance on the side closest to the blower fan and becomes progressively grater or smaller than the optimal pitch Po at positions spaced apart from the blower fan 120. As the fold pitch P of the filter 170 is changed in this way, the flow velocity distribution of air passing through the filter 170 can be made uniform.

In the car air conditioner according to the invention, the fold pitch P of the filter 170 is divided into a plurality of stages and is the same inside each of the stages. In this case, production cost is less than when the tuck fold is changed for each peak.

In the car air conditioner according to the invention, the fold pitch P is made gradually greater or smaller without any steps. This construction can accomplish a uniform flow velocity distribution of air passing through an extremely fine filter.

In the car air conditioner according to the invention, the filter 170 is folded into a fold shape, a top position of a peak of each fold is at the same height from a horizontal plane in a transverse direction or a vertical plane in a vertical direction of the car body on the upstream side of an air flow, a bottom position of a valley of each of the folds is at a different height on the side of the heat exchanger, and the height h of the peak of the fold is greater on the side closer to the blower fan 120 and is smaller on the side spaced apart from the blower fan 120. The flow velocity distribution of air passing through the filter can be made uniform, too, by changing the height h of the peak of each fold of the filter. The greater the height h of the peak of the fold, the greater the filter area per unit area in the air blowing direction. Therefore, the quantity of air passing through the filter 170 per unit area decreases and blast resistance decreases. The flow velocity distribution of air passing through the heat exchanger 130 can thus be made uniform.

In the car air conditioner according to the invention, the height h of the peak of the fold is divided into a plurality of stages and is the same inside each of the stages. In this case, production cost is less than when the height h of the fold pitch is changed for each peak.

In the car air conditioner according to the invention, the height h of the peak of the fold of the filter 170 gradually decreases without any steps. This construction can accomplish a uniform flow velocity distribution of air passing through an extremely fine filter.

In the car air conditioner according to the invention, a mass per unit area M or mesh size of a filter material constituting the filter 170 is smaller on the side closer to the blower fan 120 and progressively increases on the side spaced apart from the blower fan 120. The flow velocity distribution of air passing through the filter 170 can be made uniform, too, by selecting the coarseness/denseness of the filter material of the filter 170.

In the car air conditioner according to the invention, the mass per unit area M or mesh size of the filter material of the filter 170 is divided into a plurality of stages and is the same in each of the stages. In this case, production cost can be kept at a low level compared to when the mass per unit area M or mesh size is changed without any steps.

In the car air conditioner according to the invention, the mass per unit area or mesh size of the filter material gradually decreases without any steps. This construction can accomplish a uniform flow velocity distribution of air passing through an extremely fine filter.

In the car air conditioner according to the invention, a wall surface 106c of the air conditioner case 101 on the upstream side of the heat exchanger 130 and facing the heat exchanger 130 is shaped to be parallel to the heat exchanger 130. Consequently, the wall surface 106c of the air conditioner case 101 need not be shaped into an inclined shape, and the width B (mm) of the car air conditioner in the longitudinal direction of the car body can be reduced (A>B).

The present invention may be more fully understood from the description of the preferred embodiments of the invention, as set forth below, together with the accompanying drawings.

### BRIEF DESCRIPTION OF THE DRAWINGS

In the drawings:

FIG. 1 is a conceptual view showing an overall construction of a car air conditioner;

FIG. 2 is an explanatory view useful for explaining characterizing portions of a car air conditioner according to the present invention;

FIG. 3 is a perspective view of a filter according to the first embodiment and is an explanatory view;

FIG. 4 is a graph showing the relationship between a fold pitch P of a fold filter and air permeation resistance;

FIG. 5 is a side view of a filter according to the second embodiment;

FIG. 6 is a side view of a filter according to the third embodiment;

FIG. 7 is an arrangement view of a filter according to the fourth embodiment and its perspective view;

FIG. 8 is a side view of a filter according to the fifth embodiment;

FIG. 9 is an arrangement view of a filter according to the sixth embodiment and a perspective view of the filter according to the second embodiment;

FIG. 10 is an arrangement view of a filter according to the seventh embodiment and its perspective view;

FIG. 11 is an explanatory view when a mass per unit area or mesh size of a filter according to the eighth embodiment is increased and decreased;

FIG. 12 is an explanatory view useful for explaining the characterizing portions of a car air conditioner according to the ninth embodiment of the invention;

FIG. 13 is a sectional view of an air conditioner in which a filter according to the prior art is installed;

FIG. 14 is a sectional view of a filter according to the prior art reference 1 and is a graph showing a flow velocity distribution inside a duct;

FIG. 15 is an arrangement view of a filter according to the prior art reference 2 and a perspective view of its filter;

FIG. 16 is an arrangement view of a filter according to the prior art reference 3 and a plan view of its filter; and

FIG. 17 is an arrangement view of a filter according to the prior art reference 4 and a partial perspective view of its filter.

### DESCRIPTION OF THE PREFERRED EMBODIMENTS

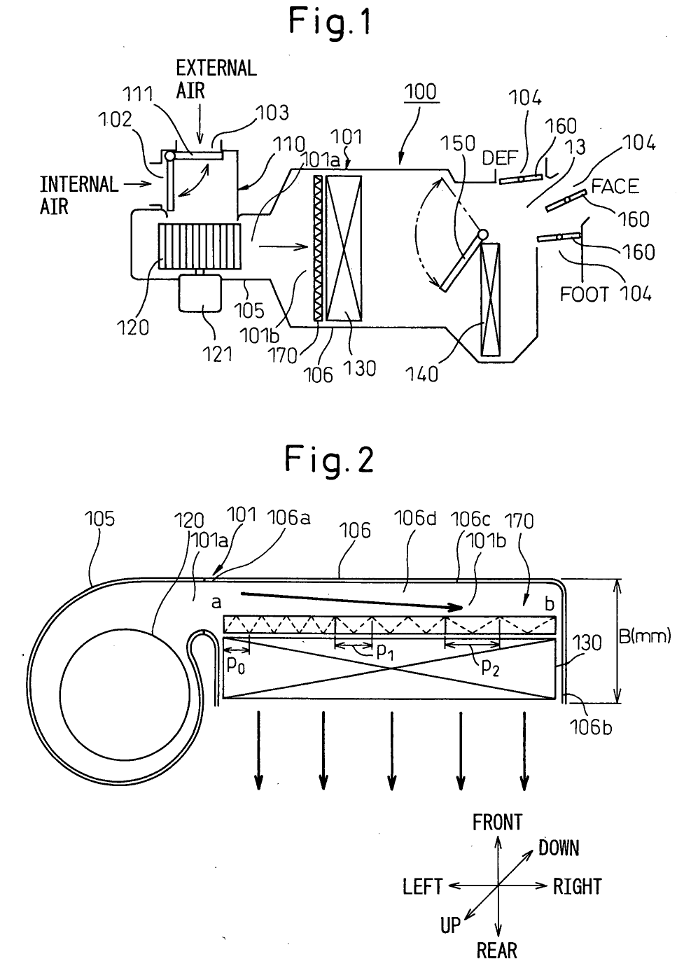

Car air conditioners according to preferred embodiments of the invention will be hereinafter explained with reference to the accompanying drawings. To begin with, the ordinary construction of a car air conditioner will be explained. FIG. 1 shows a schematic overall construction of a car air conditioner. The car air conditioner 100 corresponds to the passenger compartment air conditioning means for heating and cooling (air conditioning) the passenger compartment. Air conditioning of the passenger compartment is achieved as air for air conditioning is blown out from various air outlets. The car air conditioner 100 is mainly installed inside an instrumental panel. A blower fan 120 (corresponding to a later-appearing blower fan 120) for feeding air is installed on the inlet side of an air conditioner case and is rotated by a fan motor 121. An internal air/external air switching box 110 is installed on the suction side of the blower fan 120. An internal air/external air switching door 111 is provided on the switching box 110. When this internal air/external air switching door 111 is switched, it is possible for an internal air suction port 102 or an external air suction port 103 from inside or outside the passenger compartment to be selectively opened, and for both suction ports 102 and 103 to opened halfway.

An evaporator 130 as air cooling means (corresponding to a later-appearing heat exchanger 130) is arranged on the downstream side of the blower fan 120. A refrigerant that circulates through a refrigeration cycle including a compressor, a condenser and an expansion valve, all of which are not shown in the drawing, is introduced into the evaporator 130 and cools air. A filter 170 is arranged adjacent to, and on the upstream side of, the evaporator 130, and purifies air inside the passenger compartment.

A heater core 140 as air heating means is arranged on the downstream side of the evaporator 130. The cooling water of an engine, not shown in the drawing, is generally introduced into the heater core 140 and heats air.

An air mix door 50 is arranged on the upstream side of the heater core 140. The rotation of this air mix door 150 changes an introduction ratio of the heater core 140 with respect to air passing through the evaporator 130. Air temperature can thus be adjusted.

Air, the temperature of which is adjusted in this way, is selected by a plurality of doors and is blown out from each blow port 104 (defrost-blow port, face-blow port, foot-blow port) to give a pleasant temperature environment to a driver and passengers inside the car.

### First Embodiment

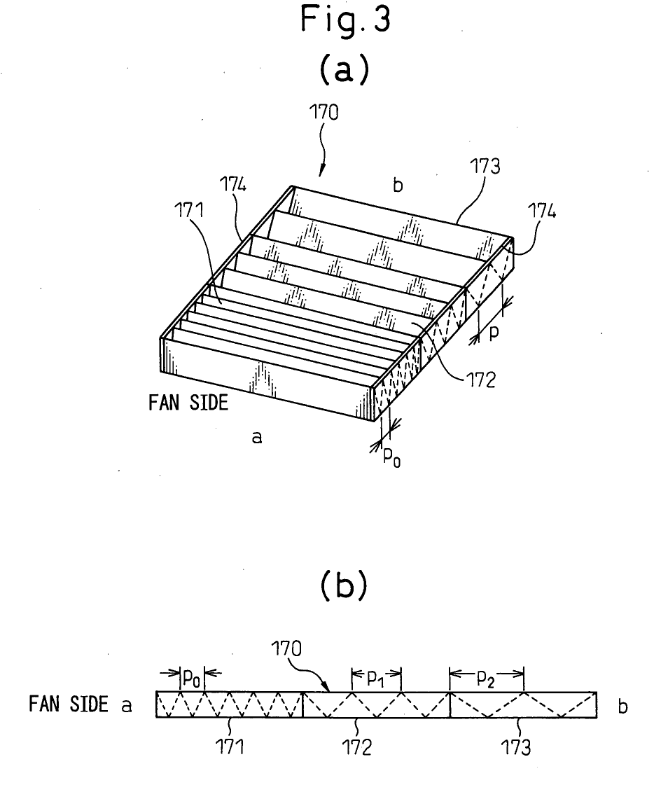

FIG. 2 shows characterizing portions of a car air conditioner according to the first embodiment of the present invention, that is, a blower offset HVAC (Heating Ventilating and Air Conditioning) unit. FIG. 3 is a perspective view of a filter of the first embodiment and is its explanatory view.

The car air conditioner according to the present invention can be broadly divided into a blower unit A and an air conditioning unit B. The blower unit A is arranged at a position that is offset from the center of the instrumental panel (not shown in the drawing) on the front side inside the passenger compartment towards the passenger's seat (towards the left in the transverse direction of the car body in the case of right-hand steering wheel cars). In contrast, the air conditioning unit B is arranged in the center of the instrumental panel on the front side of the passenger compartment.

The blower unit A includes an internal air/external air switching box (see FIG. 1) for selectively introducing internal and external air, and a blower fan consisting of a centrifugal multi-blade fan (Silocco fan) is arranged downstream of this switching box. The blower fan 120 is housed in a casing 105 (scroll casing) formed of a resin, having a suction port that is open in the forward direction of the car body, and blowing air in the transverse direction of the car body. A motor (see FIG. 1) for driving the blower fan 120 is assembled with the blower fan 120. The spindle of the blower fan 120 is arranged so as to face in the vertical direction of the car body. Air sucked from the internal air/external air switching box through the suction port of the blower case 105 by the rotation of this blower fan 120 is blown horizontally (in the transverse direction of the car body) towards the blow ports of the blower case 105 facing the transverse direction of the car body.

On the other hand, the air conditioning unit B has a heat exchanger case 106 formed of a resin. The heat exchanger case 106 has a box shape. A portion of the box (wall surface) 105c on the front side of the car is closed and a portion 106b on the back side of the car is a connection portion that is connected to the blast passage on the downstream side of the air flow. An air inlet 106c is disposed at a lower part of the side surface facing the blast port of the blower case 105 and is connected to the blast port of the blower case. An air flow inflow space 106d into which air flows from the air inlet portion 106a is defined at the foremost portion of the car inside the heat exchanger case 106. An evaporator (heat exchanger) 130 constituting the refrigeration cycle is horizontally arranged in the transverse direction of the car body at a portion (connection portion) 106b of the heat exchanger case 106 on the back side of the car body.

In this way, a part of the air conditioner case 101 of the car air conditioner described above is constituted by the blower case 105 and the heat exchanger case 106. After the flowing direction of air entering from the suction port opening in the forward direction of the car is changed by the blower fan 120, air is allowed to flow horizontally in the transverse direction of the car body inside the first airflow passage 101a. The flowing direction of air is changed 90° in the air inflow space 106 of the second blast passage 191b, and first and second continuous airflow passages 101a and 101b are formed for flowing air in the rear direction of the car body. Incidentally, the blow port of the blower case 105 and the air inlet portion 106a of the heat exchanger case 106 may be connected through a horizontal communication duct that is horizontal in the transverse direction of the car without directly connecting them together. The air flow may also be changed 90° in the upward direction from the transverse direction of the car body.

The blower fan 120 and the heat exchanger 130 are arranged (in an offset arrangement) adjacent to each other in the transverse direction of the car body inside the air conditioner case 101.

In the car air conditioner according to the present invention, the heat exchanger 130 is an evaporator inside the refrigeration cycle, in which refrigerant flows in the closed circuit consisting of a compressor, a condenser, an expansion valve, an evaporator, a gas-liquid separator, etc. The evaporator 130 can be Various constructed in various ways. For example, a pair of thin metal sheets excellent in corrosion resistance, such as aluminum are bonded together to form a flat tube, and the flat tubes, along with aluminum corrugate fins are alternately stacked to form a heat exchanger core portion. Air exchanges heat with refrigerant flowing inside the tube and is cooled when air passes on the outside of the tubes of this heat exchanger core portion.

In the car air conditioner according to this embodiment, the closed portion (wall surface) 106c of the heat exchanger case 106 (air conditioner case 101) on the front side of the car opposing the heat exchanger 130 on the upstream side of the heat exchanger 130 and the heat exchanger 130 arranged horizontally at the connection portion 106b of the heat exchanger case 106 (air conditioner case 101) on the rear side of the car are parallel to each other. Therefore, the air inflow space 106d has a flat rectangular shape.

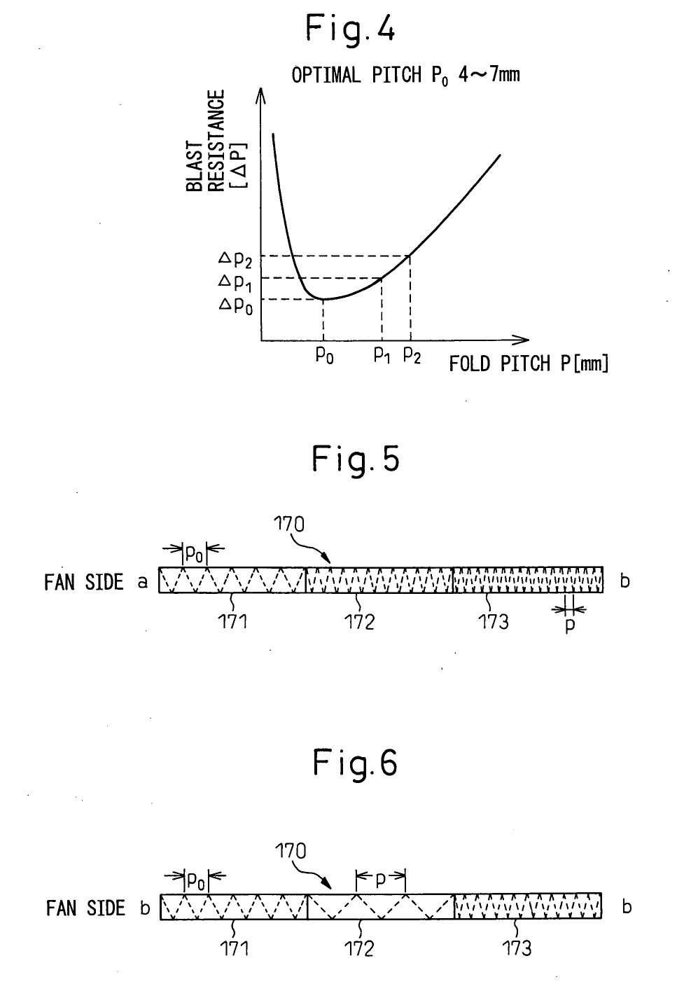

A filter 170 as a feature of the present invention is horizontally disposed in the transverse direction of the car body adjacent to, and on the upstream side of, the heat exchanger 130 inside the heat exchanger case 106 (air conditioner case 101) in such a manner as to cover substantially the entire surface of the heat exchanger core portion, and removes dust and straightens the air flow of air before it passes through the heat exchanger 130. Particles of active carbon are mixed to provide a deodorizing function to the filter 170 or a series of non-woven fabrics or filter paper are processed into a corrugated fold form without mixing the active carbon. Incidentally, the term “fold form” means a wave form (corrugate form) in which peaks (convex portions) and valleys (concave portions) alternately continue to form a corrugated shape. The filter 170 is equipped with a frame member 174. FIG. 4 is a graph showing the relationship between a fold pitch P (mm) of fold and airflow resistance (ΔP). In this case, the “fold pitch P” is a gap between the tops of two continuous peaks. It can be understood from the diagram that the fold pitch P of 4 to 7 mm is an optimum pitch Po and airflow resistance is minimal, and airflow resistance increases when the pitch P deviates up and down from the optimum pitch Po. The fold pitch providing minimum airflow resistance will be hereinafter called “optimal pitch Po”.

In other words, because the filter area per unit area in the air blowing direction increases when the fold pitch P of the filter 170 is at the optimal pitch Po (4 to 7 mm), the quantity of air passing through the filter 170 per unit area decreases and airflow resistance is less. When the fold pitch P is smaller than the optimal pitch Po, the gap between the peak and valley of each fold decreases and fluid friction increases. When the fold pitch P is greater than the optimal pitch Po, the quantity of air passing through the filter 170 per unit area in the air blowing direction increases and hence, airflow resistance increases.

Consequently, in the filter according to the first embodiment shown in FIG. 3, the filter 170 is constituted by first to third zones 171, 172 and 173 and the fold pitch P of each of the zones 171 to 173 is gradually changed in three stages. In other words, in the first zone 171 of the filter 170 in the proximity of the blower fan 120, the filter is folded at the optimal pitch Po at which airflow resistance is lowest, and as the position is spaced away from the blower fan 120 as in the second and third zones 172 and 173, the fold pitch P is increased and the fold is made at pitches P₁ and P₂ having a high airflow resistance. Incidentally, the fold pitch is the same pitch P in each zone 171 to 173.

In this case, when airflow resistance of the filter 171 of the first zone that is folded at the optimal pitch Po is ΔPo as shown in FIG. 4, the blast resistance ΔP, of the second zone is set to be (1.2 to 1.8)ΔPo and airflow resistance ΔP₂ of the filter 173 in the third zone is preferably set to (1.8 to 2.5)ΔPo.

Therefore, in the construction of the filter 170 according to this embodiment, the fold pitch is the optimal pitch Po having the lowest airflow resistance in the proximity of the blower fan 120 having a low flow velocity, and as the flow velocity increases at positions spaced away from the blower fan 120, the fold pitch P becomes greater than the optimal pitch Po to increase the blast resistance. As a result, the flow velocity distribution of air passing through the filter can be rendered uniform. Incidentally, the filter 170 is divided into three stages in the embodiment described above, but the number of zones is not limited to three, but only needs to be divided into a plurality of zones. When the filter 170 is divided into four or more zones, the folds are formed in such a manner that airflow resistance ΔP of the filter that is spaced farest from the filter fold at the optimal pitch Po falls within the range of 1 to 2.5 times the airflow resistance ΔPo of the optimal pitch Po.

In this embodiment, the filter 170 is arranged on the upstream side of the heat exchanger (evaporator) 130. Therefore, the wall surface 106c of the air conditioner case 101 facing the heat exchanger 130 on the upstream side of the heat exchanger 130 needs not be shaped into a step-like slope as has been necessary in the prior art, and the wall surface 106c of the heat exchanger case 105 connected to the blower case 105 needs only be arranged parallel to the heat exchanger 130 that is in turn arranged horizontally in the transverse direction of the car body. Therefore, the construction of the air conditioner case 101 can be simplified and the production cost can be lowered. Because the wall surface 106c of the air conditioner case 101 need not be processed into the slope surface, the size can be reduced (A>B) in the longitudinal direction (L direction of HVAC).

### Second Embodiment

FIG. 5 shows a filter according to the second embodiment. In the second embodiment, the filter 170 is constituted by three zones 171, 172 and 173 and the fold pitch P of each zone is gradually changed in three stages in the same way as in the first embodiment. However, whereas the fold pitch P of each zone is greater than the optimal pitch Po at a position spaced further apart from the side of the blower fan 120 in the first embodiment, fold is made at the optimal pitch Po providing the lowest airflow resistance Pa in the first zone 171 in the proximity of the blower fan 120 in this second embodiment. In the second and third zones 172, 173 that are spaced apart from the blower fan 120, the fold pitch P is made smaller to a pitch providing greater airflow resistance ΔP that provides large influences of fluid friction. Incidentally, the number of the zones of the filter 170 is not limited to three and the filter needs only be divided into a plurality of zones.

### Third Embodiment

FIG. 6 shows a filter according to the third embodiment. In the third embodiment, the filter 170 is constituted of three zones 171, 172 and 173. The tuck weaving pitch P of the first zone 171 in the proximity of the blower fan 120 is set to the optimal pitch Po. In the second zone 172 spaced apart progressively from the blower fan 120, the fold pitch P is greater than the optimal pitch Po and in the third zone 173, the fold pitch P is made smaller than the optimal pitch Po. It is possible in this way to set the fold pitch P to the optimal pitch Po in the first zone 171 closest to the blower fan 120 and to have the fold pitch greater or smaller than the optimal pitch Po in the zones 172 and 173 at positions spaced away from the blower fan 120. In this case, similar functions and effects can be obtained as in the first embodiment.

### Fourth Embodiment

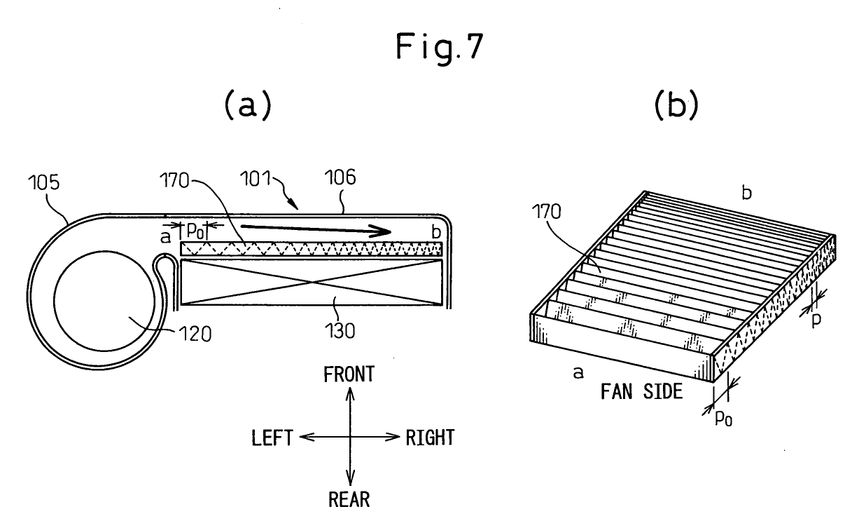

FIG. 7 shows a filter according to the fourth embodiment. In this fourth embodiment, the fold pitch P of the filter 170 is made smaller gradually and without steps in such a manner as to correspond to the flow velocity distribution of the filter inflowing air. Namely, the fold pitch P of the filter reaches the maximum in the proximity of the blower fan where flow velocity is low, and gradually becomes smaller at the positions spaced apart from the blower fan 120. In this case, it is necessary to set the greatest pitch P in the proximity of the blower fan 120 to the optimal pitch Po. A predetermined number of fold pitches P counted from the blower fan side may be kept within the range of the optimal pitch Po without setting only one fold pitch in the proximity of the blower fan 120 to the optimal pitch Po. A fold is made in such a manner that when the filter 170 has no steps, the blast resistance ΔP of the filter farthest from the filter folded at the optimal pitch Po is within the range of 1 to 2.5 times the blast resistance Po of the optimal pitch, in the same way as in the case of folding four or more stages.

The fourth embodiment can further accurately make the flow velocity distribution of passing air of the filter 170 more uniform.

### Fifth Embodiment

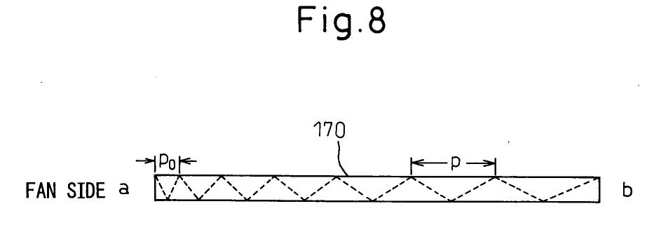

FIG. 8 shows a filter according to the fifth embodiment. In the fourth embodiment, the fold pitch P of the filter 170 becomes progressively smaller without any steps when the filter 170 is spaced away from the blower fan 120. In this fifth embodiment, the pitch becomes progressively greater without any steps from the optimal pitch Po.

In this case, similar functions and effects can be obtained in the same way as in the fourth embodiment.

### Sixth Embodiment

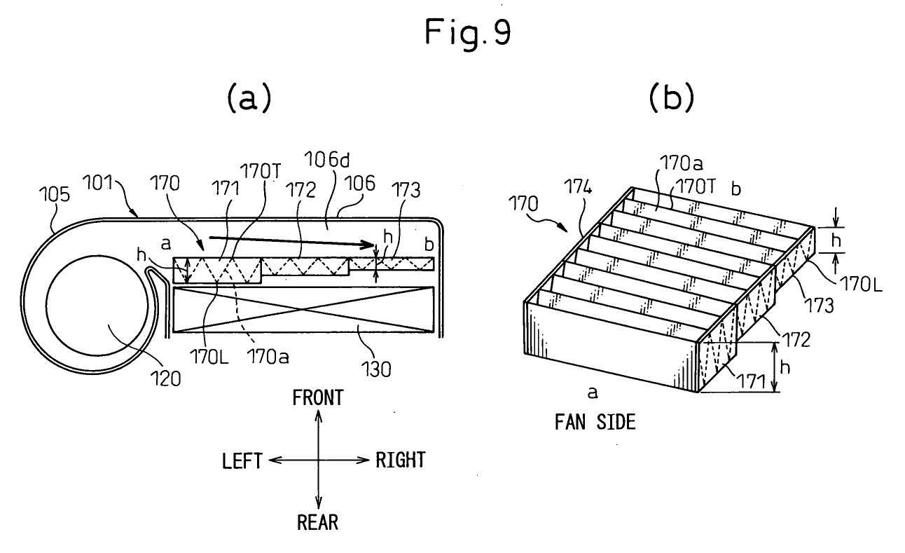

FIG. 9 shows a filter according to the sixth embodiment. In this sixth embodiment, the fold pitch P of the filter 170 is not gradually changed, but the height h of the peak of the fold that is folded is gradually changed in three stages. The peak height h of the fold generically represents the gap of the top of the peak and the bottom of the valley between adjacent peaks. In other words, the greater the peak height h of the filter 170, the greater the filter area per unit area in the air blowing direction. Therefore, the quantity of air passing through the unit area of the filter 170 is reduced and airflow resistance is also reduced.

In this sixth embodiment, the filter 170 is divided into first, second and third zones 171, 172 and 173 in the same way as in the first embodiment and the peak height h of the fold 170a of the filter 170 in each zone 171 to 173 is made gradually smaller. In other words, in the first zone 171 in which the flow velocity is less in the proximity of the blower fan 120, the peak height h of the fold is the greatest and is gradually decreased in the second and third zones 172 and 173 spaced away from the blower fan 120. The flow velocity distribution of air passing through the filter 170 is rendered uniform in this way. The position of the top 170T of the peak of each fold on the upstream side of the air flow in the filter 170 of each of the zones 171 to 173 is set to the same height from the flat plane horizontal in the transverse direction of the car body, and the position of the bottom 170L of the valley of each fold on the side of the heat exchanger 130 has a different height in each zone. In other words, the position of the valley bottom 170L of each tuck 170a of the filter 170 in each of the first to third zones 171 to 173 is step-wise greater. According to this arrangement, air can be blasted to the depth of the air inflow space 106d of the upstream portion of the heat exchanger that is spaced apart from the blower fan 120.

In the sixth embodiment described above, an explanation is given in which the filter 170 is divided into first to third zones 171 to 173. However, the filter 170 may be divided into three or more zones and the height h of the peak of the fold may be divided into a plurality of stages.

The top position 170T of the peak of each tuck on the upstream side of the air flow of the filter 170 of each of the first to third zones 171 to 173 is at the same position from the horizontal flat plane in the transverse direction of the car body and at a different height at the bottom position 170L of the valley of each fold on the heat exchanger side. Assuming that the top position 170T of the peak of each fold on the downstream side, but not on the upstream side exists at the same height from the horizontal flat plane in the transverse direction of the car body, the filter 170 is formed in such a fashion that the height of the folds becomes progressively smaller closest to the blower fan 120 to the far side in order to make uniform air flow velocity distribution. The air inflow space 106d on the upstream side of the heat exchanger 130 spaced apart from the blower fan 120 has a rapidly expanding shape owing to the shape of the filter 170 on the upstream side. Consequently, air flowing from the blower side to the air inflow space 106d can further flow into the depth owing to this rapidly expanding shape. This offsets the effect (effect of making uniform the flow velocity distribution) obtained by increasing the pressure loss of the filter 170 at the portion spaced apart from the blower fan 120. In contrast, when the height of the top is at the same height from the flat plane horizontal in the transverse direction of the car body and the bottom position 170L of the valley of each tuck is at the different height, the shape of the filter 170 does not affect the air stream at the air inflow space 106d.

### Seventh Embodiment

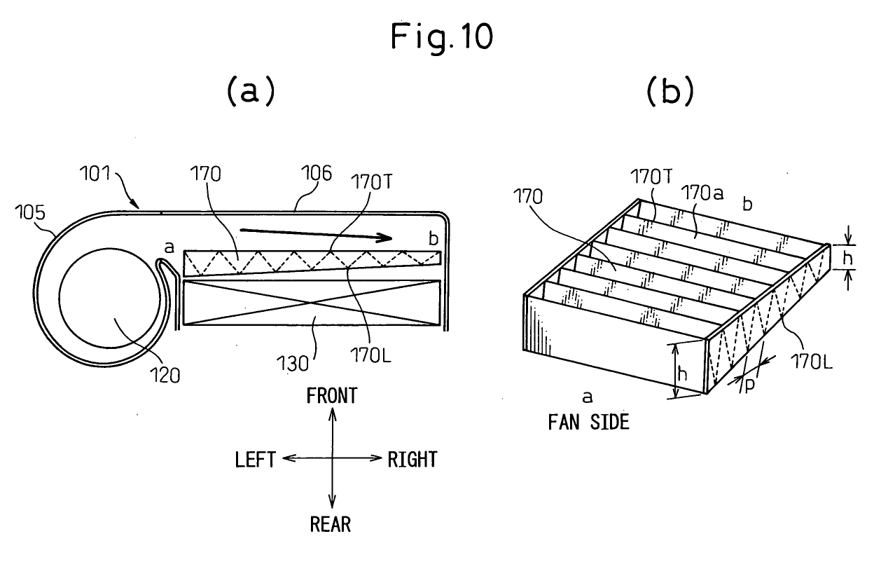

FIG. 10 shows a filter according to the seventh embodiment. In this seventh embodiment, the height h of the fold of the filter 170 is gradually decreased without any steps in accordance with the filter inflow air velocity distribution. In other words, at the portion closest to the blower fan 120 where the flow velocity is lowest, the height h of the fold of the filter 170 is the greatest and as the position increases away from the blower fan 120, the height h of the fold is gradually lowered. In this case, the fold pitch P of the filter 170 is not changed. In this case, the position 170T of the top of the peak of the fold of the filter 170 on the upstream side of the air flow must be at the same height from the flat plane horizontal in the transverse direction of the car body. The position 170L of the bottom of the valley of each fold 170a is at the different position on the upper side of the filter 170 facing the heat exchanger 130. Namely, the position of the bottom 170L becomes progressively higher as the filter is spaced away from the blower fan 170. In this seventh embodiment, the flow velocity distribution of passing air of the filter 170 can be made more uniform with higher accuracy.

### Eighth Embodiment

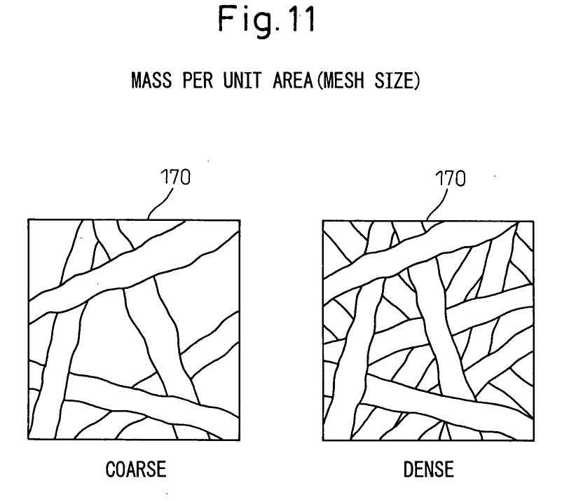

In the foregoing embodiments, the blast resistance is changed by changing the pitch P of the fold or the height h of the peak of the fold as the shape of the filter 170, but in the eighth embodiment, the blast resistance may be changed by changing the mass per unit area (g/cm²; coarseness/density) or mesh size representing the weight of the filter material per unit area as shown in FIG. 11. Namely, the mass per unit area is decreased in the proximity of the blower fan 120 and is increased at portions spaced apart from the blower fan 120. In this case, the mass per unit area may be changed dividedly in a plurality of stages or may be changed gradually without step. Furthermore, the fold pitch P, the height h of the peak of the fold and the mass per unit area may be combined with one another in various ways to gradually change airflow resistance of the filter 170.

### Ninth Embodiment

In the first to eighth embodiments described above, an explanation has been given in the assumption that the blower fan 120 and the heat exchanger 130 are arranged in the transverse direction of the car body in the car air conditioner 100. In this ninth embodiment, the filter 170 according to the present invention is applied to the car air conditioner in which the blower fan 120 and the heat exchanger 130 are arranged in the vertical direction (direction of height) of the car body. The basic construction of the car air conditioner 100 in the ninth embodiment is the same as the construction shown in FIG. 1. The blower fan 120 is disposed on the inlet side of the air conditioner case 101 and the evaporator (heat exchanger 130) as the air cooling means is arranged on the downstream side of the blower fan 120. The heater core 140 as the air heating means is arranged further downstream of the evaporator 130. The air mix door 150 is arranged upstream of the heater core 140 and the rotation of this air mix door 150 changes the introduction ratio of passing air of the evaporator (heat exchanger 130) into the heater core 140 to thereby adjust the temperature of blown air. After temperature adjustment, air is selected by a plurality of doors such as the mode switching door 160 and is blown into the passenger compartment from each blow port 104 (defrost-blow port, face-blow port, foot-blow port, etc).

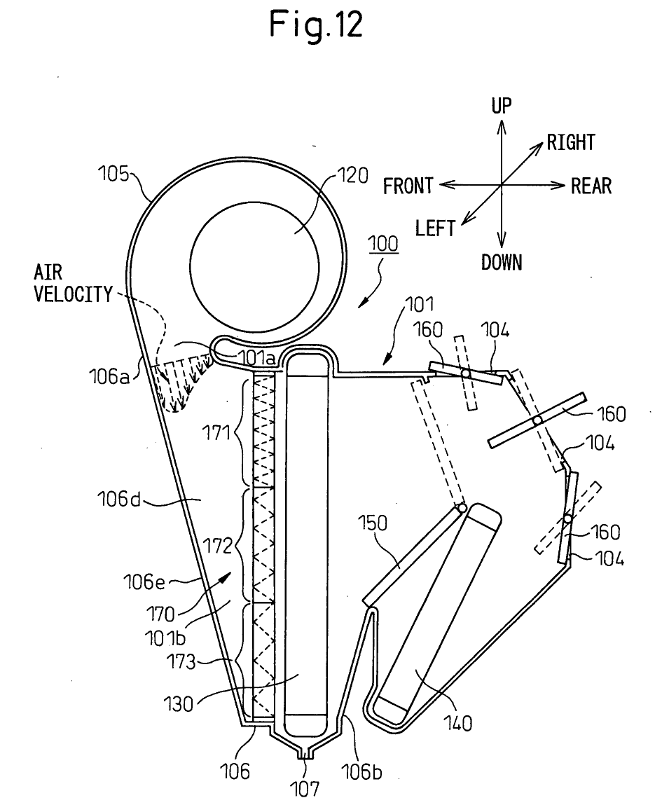

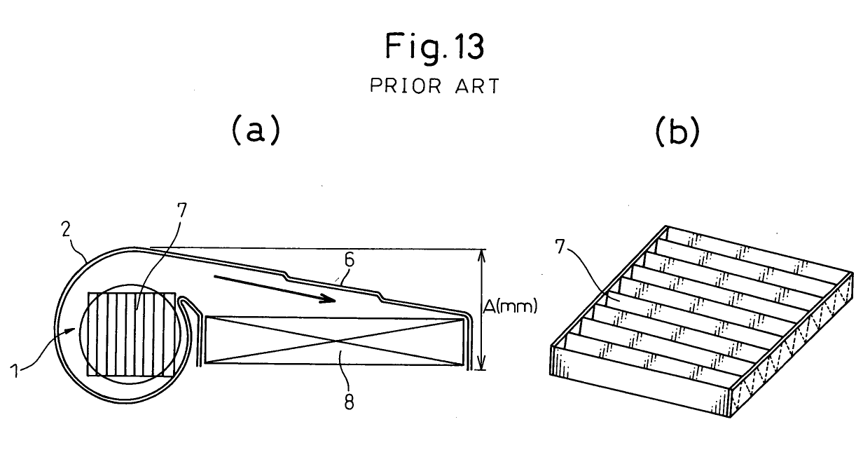

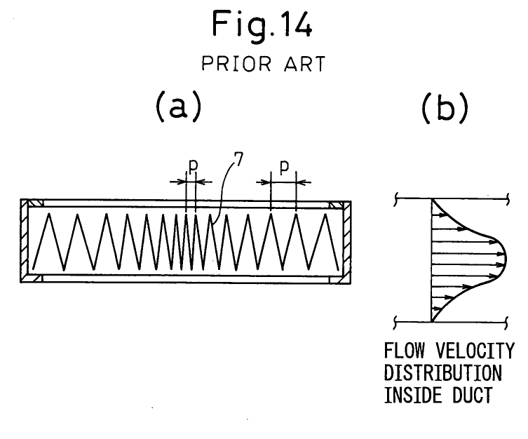

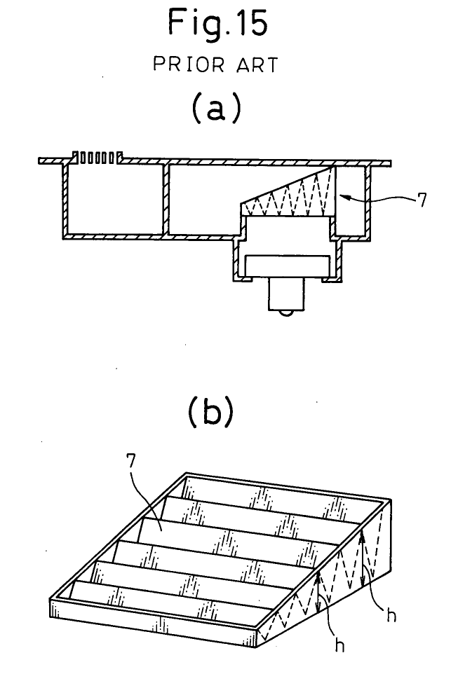

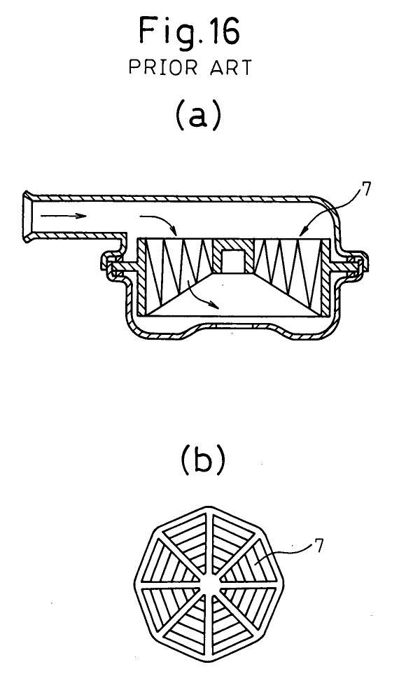

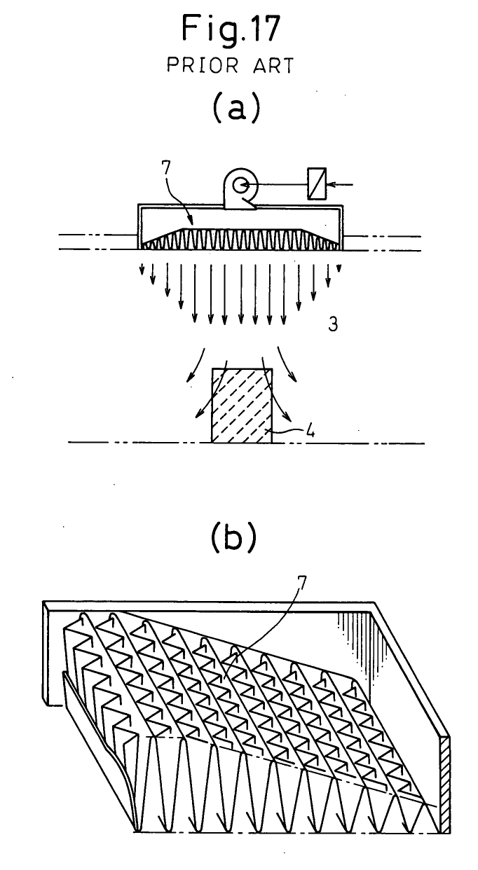

The car air conditioner 100 is broadly divided into the blower unit A and the air conditioner unit B. In the ninth embodiment, the blower unit A is arranged in the center of the instrumental panel (not shown) in the front part of the passenger compartment and the air conditioner unit B is arranged adjacent to the blower unit A in the vertical direction of the car body. The blower unit A includes an internal air/external air switching box (see FIG. 1) for switching and introducing the internal air and external air of the passenger compartment and the blower fan 120 consisting of a centrifugal multi-blade fan (Silocco fan) is disposed on the downstream side of this internal air/external air switching box. The blower fan 120 is incorporated in a blower case (scroll casing) 105 formed of a resin, having a suction port opening in the forward direction of the car body and forming the air passage for sending air in the vertical direction of the car body (down direction in FIG. 12). A motor (see FIG. 1) for driving the blower fan 120 is assembled on the blower fan 120. The spindle of the blower fan 120 is so arranged as to extend in the transverse direction of the car body. Air sucked by the rotation of the blower fan 120 from the internal air/external air switching box through the suction port of the blower case 105 is blown in a vertical direction (up-down direction of the car body) towards the blast port of the blower case 105 facing the vertical direction (down direction in FIG. 12) of the car body.

On the other hand, the air conditioner unit B has a heat a exchanger case 106. The heat exchanger case 06 has a box shape, which is closed at a portion (wall surface) 106e on the front side of the car, the portion 106b of which on the rear side of the car body is a connection portion connected to the blast passage on the downstream side of the air flow, the upper surface of which faces the blast port of the blower case 105 and has an air inlet portion 106a, and which is connected to the blast port of the blower case 105. An inflow space into which air from the air inlet portion flows is formed at a port on the foremost side of the car body. An evaporator (heat exchanger) 130 constituting a refrigeration cycle is installed in the vertical direction of the car body at the portion (connection portion) 106b of the heat exchanger case 106 on the downstream side of the air inflow space 106d.

A part of the air conditioner case 101 of the car air conditioner described above is constituted by the blower case 105 and the heat exchanger case 106. Air flowing through the suction port opening in the front direction of the car body is allowed to flow vertically in the vertical direction (direction of height) of the car body inside a first blast passage 101a after its flowing direction is changed by the blower fan 120, its flowing direction is then changed 90° in the air inflow space 106d and air is allowed to flow towards the rear part of the car body through first and second continuous airflow passages 101a and 101b. In other words, the blower 120 and the heat exchanger 130 are arranged adjacent to each other in the vertical direction of the car body inside the air conditioner case 101.

The heat exchanger 130 is an evaporator in the refrigeration cycle in which the refrigerant flows in a closed circuit consisting of a compressor, a condenser, an expansion valve, an evaporator, a gas-liquid separator, etc, and is arranged in the vertical direction inside the heat exchanger case 106 where both headers are arranged in the vertical direction. A drain port 107 for discharging drain water is formed in the lower surface of the heat exchanger case 106, in which the heat exchanger 130 is installed. As the air stream flows substantially horizontally in the longitudinal direction outside the tubes of the heat exchange core portion of the heat exchanger 130, heat exchange is executed with the refrigerant flowing inside the tubes in the vertical direction.

In the ninth embodiment, the closed portion (wall surface) 106e of the heat exchanger case 106 (air conditioner case 101) on the front side of the car body facing the heat exchanger 130 on the upstream side of the heat exchanger 120 installed in the substantial vertical direction is inclined in such a manner as to approach the heat exchanger 130 as it comes away from the blower fan 120, and blown air 130 flows to this inclined wall surface 106e and the heat exchanger 130. The air inflow space 106d thus formed has an inverted trapezoidal section. As represented by the flow velocity distribution of the blast port of the blower case in FIG. 12, the stream of air blown out from the blast port of the blower case (scroll casing) 105 has a high flow velocity on the outer peripheral side (winding end side) owing to inertia, and the air stream flowing into the heat exchanger 130 is rendered uniform by gradually decreasing the gap between the inclined wall surface 106e of the heat exchanger case 106, and the heat exchanger 130.

The filter 170 as a feature of the present invention is vertically disposed in the vertically direction of the car body adjacent to, and on the upstream side of, the heat exchanger 130 inside the heat exchanger case 106 (air conditioner case 101) in such a manner as to cover the entire surface of the heat exchanger core portion, removes dust, and straightens the air flow of air before it passes through the heat exchanger 130. The filter 170 is constituted by first, second and third zones 171, 172 and 173 in the same way as in the first embodiment and the fold pitch P of each of these zones 171 to 173 is gradually changed in three stages. In other words, the fold is made at the optimal pitch Po having the lowest airflow resistance in the filter 171 of the first zone positioned at the upper stage in the vertical direction of the car body and adjacent to the blower fan 120. The fold pitch P is somewhat increased in the filter 173 of the second zone positioned at the intermediate stage and fold is made at a pitch P1 having a higher airflow resistance. The fold pitch P is further increased in the filter 173 of the third zone positioned at the lower stage and fold is made at a pitch P2 having a high airflow resistance.

In the construction of the filter 170 according to the ninth embodiment, the fold pitch is set to the optimal pitch Po having the lowest airflow resistance to the proximity of the blower fan 120 having a small flow velocity and the fold pitch P is progressively increased (P1, P2) from the optimal pitch Po with a greater distance from the blower fan 120 and a greater flow velocity to increase the airflow resistance. Because the air inflow space 106 to the heat exchanger 130 has an inverted trapezoidal shape, flow velocity distribution of air passing through the filter can be made further uniform. Incidentally, in the embodiment described above, the filter 170 is divided into three stages, but the number of stages is not limited to three (3), but may be divided into a plurality of stages.

As explained with reference to the ninth embodiment, the filter construction as the feature of the present invention can be applied to the car air conditioner 100 having the blower 120, and the heat exchanger 130 arranged adjacent to each other in the vertical direction of the car body inside the air conditioner case 101, and the filter constructions explained in the second to eighth embodiments can also be suitably adopted.

While the invention has been described with reference to specific embodiments chosen for purposes of illustration, it should be apparent that numerous modifications could be made thereto by those skilled in the art without departing from the basic concept and scope of the invention.

1. An air conditioner comprising:
an air conditioner case having a first airflow passage for causing air sucked from a suction port to horizontally flow in a transverse direction (direction of width) of a car body or vertically in a vertical direction of the car body and a second airflow passage for changing the flowing direction of an air stream from said first airflow passage substantially 90° and sending it towards a blow port;
a blower fan arranged inside said air conditioner case, for blowing air sucked from said suction port in the transverse direction or vertical direction of the car body towards said first airflow passage;
a heat exchanger aligned with said blower fan in the transverse direction or vertical direction of the car body inside said air conditioner case, and arranged inside said second airflow passage; and
a filter arranged on the upstream side of said heat exchanger inside said second airflow passage;
wherein said filter is constituted in such a manner that airflow resistance of said filter becomes smaller on the side closer to said blower fan and becomes progressively greater at positions spaced apart from said blower fan with respect to a flow velocity of air passing through said filter.

2. A car air conditioner according to claim 1, wherein said filter is folded, and a fold pitch (P) is an optimal pitch (Po) having the smallest airflow resistance on the side closer to said blower fan and becomes progressively greater or smaller than said optimal pitch (Po) at positions spaced apart from said blower fan.

3. A car air conditioner according to claim 1, wherein said fold pitch (P) is divided into a plurality of stages and is the same inside each of said stages.

4. A car air conditioner according to claim 1, wherein said fold pitch (P) becomes gradually greater or smaller without any steps.

5. A car air conditioner according to claim 1, wherein said filter is folded into a tuck shape, a top position of a peak of each fold is at the same height from a plane horizontal in a transverse direction of a car body or a plane vertical in a vertical direction of the car body on the upstream side of an air flow, a bottom position of a valley of each of said folds is at a different height position on the side of said heat exchanger, and the height (h) of the peak of said fold is greatest on the side closest to said blower fan and is smallest on the side away from said blower fan.

6. A car air conditioner according to claim 5, wherein the height (h) of the peak of said fold is divided into a plurality of stages and is the same inside each of said stages.

7. A car air conditioner according to claim 5, wherein the height (h) of the peak of said fold gradually decreases without any steps.

8. A car air conditioner according to claim 1, wherein a mass per unit area or mesh size of a filter material constituting said filter is smaller on the side closest to said blower fan and is greater on the side furthest from said blower fan.

9. A car air conditioner according to claim 8, wherein said mass per unit area or mesh size of said filter material is divided into a plurality of stages and is the same in each of said stages.

10. A car air conditioner according to claim 8, wherein said mass per unit area or mesh size of said filter material gradually decreases without any steps.

11. A car air conditioner according to claim 1, wherein a wall surface (106a) of said air conditioner case (101) on the upstream side of said heat exchanger (130) and facing said heat exchanger (130) is shaped to be parallel to said heat exchanger (130).
